(19) United States
(12) Patent Application Publication
(10) Pub. No.: US 2006/0093863 A1
(43) Pub. Date: May 4, 2006

(54) Magnetic recording medium, manufacturing process thereof, and magnetic recording apparatus

(75) Inventors: Yuko Tsuchiya, Tokorozawa (JP); Masafumi Mochizuki, Chigasaki (JP); Teruo Kohashi, Hachioji (JP); Hiroshi Ikekame, Fuchu (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/200,001

(22) Filed: Aug. 10, 2005

(30) Foreign Application Priority Data
Oct. 29, 2004 (JP) 2004-316616

(51) Int. Cl. G11B 5/66

(52) U.S. Cl. 428/827; 427/127

(57) ABSTRACT

A discrete track type perpendicular magnetic recording medium and a manufacturing method thereof are provided where the crystallographic orientation and perpendicular magnetic anisotropy of the magnetic recording layer are excellent, the magnetic properties of the magnetic recording layer are not deteriorated by processing, the manufacturing cost is not expensive, and a complicated manufacturing process is not required. A concavo-convex pattern structure consisting of a convex part corresponding to the position of the data track recording magnetic information and a concave part corresponding to the position of the space between data tracks is provided, and the base layer for controlling crystallographic orientation and the magnetic recording layer are stacked without voids on the concave and convex parts along the concavo-convex pattern structure.

### CLAIM OF PRIORITY

The present application claims priority from Japanese application JP 2004-316616 filed on Oct. 29, 2004, the content of which is hereby incorporated by reference into this application.

### FIELD OF THE INVENTION

The present invention relates to a magnetic recording medium or thermal or optical magnetic recording medium for a magnetic disk device and a hard disk drive using these recording media.

### BACKGROUND OF THE INVENTION

Recently, the improvement in recording density of a magnetic recording medium has progressed as a consequence of the increase in the density of a hard disk drive. In a current longitudinal magnetic recording system, magnetization information exists stabilized parallel to the surface of a media substrate and along the write head traveling direction. Since the size of one recording bit is reduced when the recording density is increased, the thermal demagnetization phenomena become noticeable in which the magnetized state on the media magnetic recording layer becomes thermally unstable. Then, the perpendicular magnetic recording system was proposed as a system which was applicable to a higher density recording. There is the feature that a perpendicular magnetic recording has stronger resistance against the thermal demagnetization compared with a longitudinal magnetic recording because the magnetization information exists stabilized along a direction perpendicular to the surface of the media substrate. It is said that magnetic recording with a recording density of 100 to 200 Gb/in² is possible by using this perpendicular magnetic recording system.

In order to achieve a further high recording density of 200 Gb/in² or more, it is necessary not only to convert the magnetic recording system from the aforementioned longitudinal to a perpendicular one, but also to change the design of the recording media. A current recording medium, or a medium which has continuous magnetic recording layer (continuous medium), is one in which each layer constituting the medium is formed uniformly and flat on the entire surface of the substrate by using a sputtering technique. When the recording density becomes 200 Gb/in² or more, side writing to the adjacent tracks becomes noticeable due to side fringing generated from the side wall of the magnetic write head, resulting in the recorded magnetization information being deteriorated. Moreover, when the magnetization information on the data track is read by a read head, the SN ratio is decreased by leakage flux from the adjacent tracks. In order to avoid such phenomena and to achieve a further improvement in the recording density, a discrete track medium, in which a magnetic recording layer does not exist between the data track having magnetic information and the adjacent data tracks, is proposed as shown in FIG. 1. In FIG. 1, code 11 means a substrate, 12 a soft magnetic underlayer, 13 a base layer for controlling crystallographic orientation, 14 a data track, 15 a groove between the data tracks, and 16 a cross-track direction.

JP-A No.119934/1981 discloses a medium as an example of a discrete track medium, in which a concentric circular or a spiral shaped concavo-convex pattern structure is formed on a substrate, and a magnetic material to be a magnetic recording layer is embedded in the concave part as shown in FIG. 2. In FIG. 2, the code 21 means a substrate or a non-magnetic material, 22 a convex part, 23 a concave part, 24 a magnetic material embedded in the concave part, and 25 a data track.

Moreover, as an example of a discrete track medium which differs in manufacturing method, JP-A No.118028/1983 and JP-A No.81640/1993 disclose a process for forming a concave part between the tracks by directly applying cutting-work to this magnetic recording layer after forming a magnetic recording layer uniformly and evenly on the entire surface of the medium substrate. FIG. 3 shows an example of a discrete track medium formed by said the aforementioned method. In FIG. 3, the code 31 means a substrate, 32 a soft magnetic underlayer, 33 a magnetic recording layer remaining after the cutting work (convex part, corresponding to a data track having magnetic information), 34 a concave part of the cutting-worked magnetic recording layer (concave part, corresponding to a space between tracks), and 35 a material embedded in the concave part. It is possible to fill a non-magnetic material, a material with a higher magnetic permeability than the magnetic recording layer, and a combination thereof to the cutting-worked magnetic recording layer.

Moreover, JP-A No.16622/2003 discloses a method in which a concavo-convex pattern structure is formed by applying cutting-work to the surface of the soft magnetic underlayer deposited on a media substrate, a non-magnetic layer being embedded into the concave part and planarized, and then a magnetic recording layer being formed evenly thereon. FIG. 4 is a schematic drawing illustrating a discrete track medium fabricated by the aforementioned method. In FIG. 4, the code 41 means a substrate, 42 a soft magnetic underlayer having a concavo-convex pattern structure, 43 a non-magnetic layer embedded into the concave part, 44 a magnetic recording layer, and 45 a date track.

### SUMMARY OF THE INVENTION

In a discrete track medium disclosed in JP-A No.119934/1981, a concentric circular or a spiral shipped concavo-convex pattern structure is formed on the surface of a substrate and a magnetic material to be a magnetic recording layer is embedded in the concave part as shown in FIG. 2 to form a data track which performs read/write of the magnetic information. In order to grow crystals in which the crystallographic orientation and the magnetic anisotropy are controlled, it is necessary to select the under layer and to optimize the sputtering conditions. Therefore, it is thought that manufacturing a magnetic material having an excellent perpendicular anisotropy into fine grooves, in which the width is several hundreds of nano-meters or less, is very difficult.

In the discrete track medium disclosed in JP-A No.118028/1983 and JP-A No.81640/1993, the concave part is provided between the tracks by directly applying cutting-work to this magnetic recording layer after the magnetic recording layer is formed uniformly and evenly on the entire surface of the medium substrate. In this method for manufacturing a medium, it is thought that manufacturing techniques such as wet-etching, RIE (Reactive Ion Etching), and various dry-etchings, etc. including a focused ion beam (FIB) are used for the cutting-work. Since these methods cut the magnetic recording layer by both chemical and physical means, there is a possibility that the magnetic properties of the magnetic recording layer used for the data track are deteriorated by the thermal history and the chemical erosion during the cutting-work even if a part corresponding to the data track is protected by a resist during the cutting-work.

In a method for manufacturing a medium disclosed in JP-A No.16622/2003, as shown in FIG. 4, a concavo-convex pattern structure is formed by a micro-fabrication technique on the soft magnetic underlayer, a non-magnetic material is embedded into the concave part and planarized by CMP (Chemical Mechanical Polishing), and then a magnetic recording layer is formed evenly thereon. In this method, the micro-fabrication is not applied to the magnetic recording layer, but a CMP process is applied to the surface of the soft magnetic underlayer connected to the magnetic recording layer to be a data track or the base layer for controlling crystallographic orientation. Although the surface is planarized by applying a CMP process, the crystal structure of the surface is made rougher by a thermal history caused by polishing and chemical erosion, etc. thereby, the possibility is very high that the crystallographic orientation and the perpendicular magnetic anisotropy of the magnetic recording layer formed thereon are deteriorated.

In the example of a medium shown in FIGS. 2 and 3, a CMP process becomes necessary for the surface of the magnetic recording layer because some kind of material is embedded in the concave part of the concavo-convex pattern structure. In this case, since the surface of the magnetic recording layer is directly treated by a CMP process, the deterioration of the magnetic properties of the magnetic recording layer cannot be avoided.

Moreover, there is a concern that the manufacturing cost is increased by introducing a CMP process in the media manufacturing process. Furthermore, since cuttings are produced by a CMP process, it is necessary to clean the working surface carefully to remove the dust created, resulting in the manufacturing process being complicated.

Then, it is an object of the present invention to provide a discrete track type perpendicular magnetic recording medium in which the crystallographic orientation and the perpendicular magnetic anisotropy of the magnetic recording layer are excellent, the magnetic properties of the magnetic recording layer not deteriorated by processing, the manufacturing cost inexpensive, and a complicated manufacturing process not required. Moreover, it is an object of the present invention to provide a manufacturing method of the aforementioned perpendicular magnetic recording medium. Furthermore, it is an object of the present invention to provide a hard disk drive using the aforementioned magnetic recording medium.

In order to achieve the aforementioned purposes, a perpendicular magnetic recording medium of the present invention which consists of stacking at least a soft magnetic underlayer, a base layer for controlling crystallographic orientation, and a magnetic recording layer, in order, on a non-magnetic substrate has a structure comprising a concavo-convex pattern structure consisting of a convex part corresponding to a data track position which records magnetic information and a concave part corresponding to a space between the proper data tracks provided on the surface of the air bearing surface side of a medium of the soft magnetic underlayer, in which the base layer for controlling crystallographic orientation and the magnetic recording layer are stacked free of voids on the concave part and convex part along the aforementioned concavo-convex pattern structure.

Moreover, a manufacturing method of a perpendicular magnetic recording medium of the present invention comprises a process for forming a soft magnetic layer on a non-magnetic substrate; a process for forming a concavo-convex pattern structure consisting of a convex part corresponding to a data track position which has magnetic information and a concave part corresponding to a space between the proper data tracks provided on the surface of the air bearing surface side of the medium of the aforementioned soft magnetic underlayer; a process for forming a base layer for controlling crystallographic orientation stacked free of voids on the concave part and convex part along the concavo-convex pattern structure on the aforementioned concavo-convex pattern structure; and a process for forming a magnetic recording layer stacked free of gaps on the concave part and convex part along the concavo-convex pattern structure on the aforementioned base layer for controlling crystallographic orientation.

According to the present invention, it is possible to provide a discrete track type perpendicular magnetic recording medium in which the crystallographic orientation and the perpendicular magnetic anisotropy of the magnetic recording layer are excellent, the magnetic properties of the magnetic recording layer not deteriorated by processing, read S/N ratio high, the manufacturing cost inexpensive, and a complicated manufacturing process not required. Moreover, a high density hard disk drive can be provided using this medium.

### BRIEF DESCRIPTION OF THE DRAWINGS

FIG. 1 is a schematic drawing illustrating a discrete track medium;

FIG. 2 is a schematic drawing illustrating a discrete track medium in which a magnetic material is embedded;

FIG. 3 is a schematic drawing illustrating a discrete track medium in which cutting-work was performed on a magnetic recording layer;

FIG. 4 is a schematic drawing illustrating a discrete track medium which has a patterned soft magnetic underlayer and a planarized magnetic recording layer;

FIG. 5 is a schematic drawing illustrating a discrete track medium of the present invention;

FIG. 6A is a drawing illustrating a concentric circular shaped concavo-convex pattern structure formed in a soft magnetic underlayer;

FIG. 6B is a drawing illustrating a spiral shaped concavo-convex pattern structure formed in a soft magnetic underlayer;

FIG. 7A is a schematic drawing of a method for fabricating a discrete track medium of the present invention;

FIG. 7B is a schematic drawing of a method for fabricating a discrete track medium of the present invention;

FIG. 7C is a schematic drawing of a method for fabricating a discrete track medium of the present invention;

FIG. 7D is a schematic drawing of a method for fabricating a discrete track medium of the present invention;

FIG. 7E is a schematic drawing of a method for fabricating a discrete track medium of the present invention;

FIG. 8A is a pattern drawing illustrating a discrete track medium in which a concavo-convex pattern structure is formed by performing micro-fabrication on the soft magnetic underlayer;

FIG. 8B is a pattern drawing illustrating a discrete track medium in which a concavo-convex pattern structure is formed by performing micro-fabrication on the soft magnetic underlayer;

FIG. 8C is a pattern drawing illustrating a discrete track medium in which a concavo-convex pattern structure is formed by performing micro-fabrication on the soft magnetic underlayer;

FIG. 8D is a pattern drawing illustrating a discrete track medium in which a concavo-convex pattern structure is formed by performing micro-fabrication on the soft magnetic underlayer;

FIG. 8E is a pattern drawing illustrating a discrete track medium in which a concavo-convex pattern structure is formed by performing micro-fabrication on the soft magnetic underlayer;

FIG. 8F is a pattern drawing illustrating a discrete track medium in which a concavo-convex pattern structure is formed by performing micro-fabrication on the soft magnetic underlayer;

FIG. 9A is a pattern drawing illustrating a discrete track medium in which a concavo-convex pattern structure is formed by patterning the cutting-work layer of the soft magnetic underlayer;

FIG. 9B is a pattern drawing illustrating a discrete track medium in which a concavo-convex pattern structure is formed by patterning the cutting-work layer of the soft magnetic underlayer;

FIG. 9C is a pattern drawing illustrating a discrete track medium in which a concavo-convex pattern structure is formed by patterning the cutting-work layer of the soft magnetic underlayer;

FIG. 9D is a pattern drawing illustrating a discrete track medium in which a concavo-convex pattern structure is formed by patterning the cutting-work layer of the soft magnetic underlayer;

FIG. 9E is a pattern drawing illustrating a discrete track medium in which a concavo-convex pattern structure is formed by patterning the cutting-work layer of the soft magnetic underlayer;

FIG. 9F is a pattern drawing illustrating a discrete track medium in which a concavo-convex pattern structure is formed by patterning the cutting-work layer of the soft magnetic underlayer;

FIG. 10A is a pattern drawing illustrating a discrete track medium in which a concavo-convex pattern structure is formed by fabricating a convex part using a plating technique.

FIG. 10B is a pattern drawing illustrating a discrete track medium in which a concavo-convex pattern structure is formed by fabricating a convex part using a plating technique;

FIG. 10C is a pattern drawing illustrating a discrete track medium in which a concavo-convex pattern structure is formed by fabricating a convex part using a plating technique;

FIG. 10D is a pattern drawing illustrating a discrete track medium in which a concavo-convex pattern structure is formed by fabricating a convex part using a plating technique;

FIG. 10E is a pattern drawing illustrating a discrete track medium in which a concavo-convex pattern structure is formed by fabricating a convex part using a plating technique;

FIG. 10F is a pattern drawing illustrating a discrete track medium in which a concavo-convex pattern structure is formed by fabricating a convex part using a plating technique;

FIG. 11 is a pattern drawing illustrating a discrete track medium in which a concavo-convex pattern structure is formed on the soft magnetic underlayer whose top layer is composed of a non-magnetic material; and

FIG. 12 is a schematic drawing of a magnetic disk of the present invention.

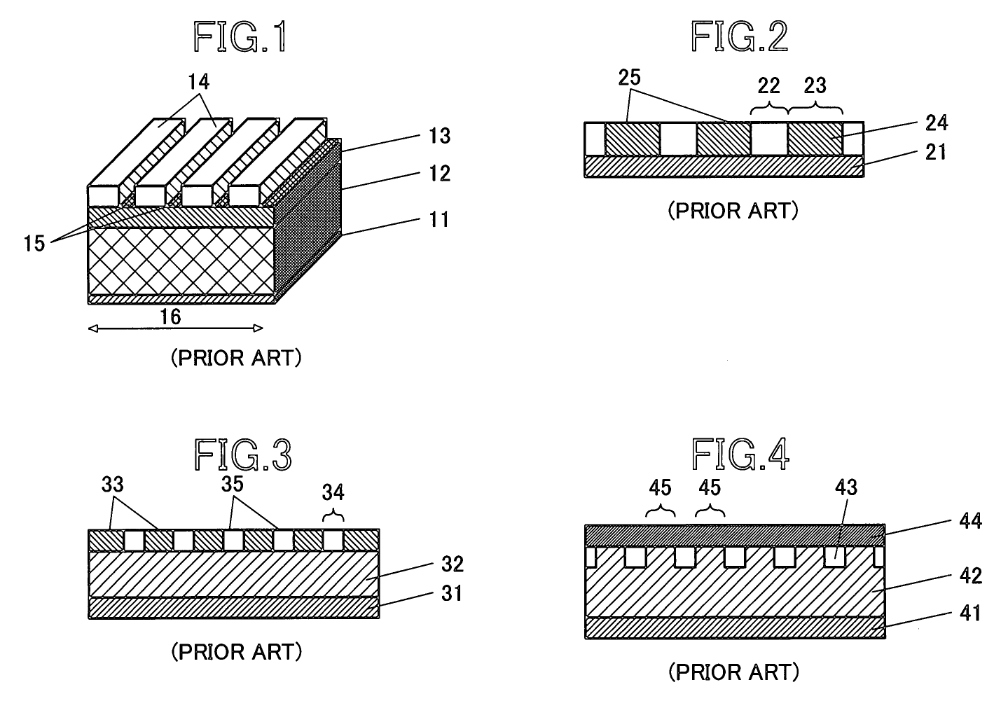

### DERAILED DESCRIPTION OF THE PREFERRED EMBODIMENTS

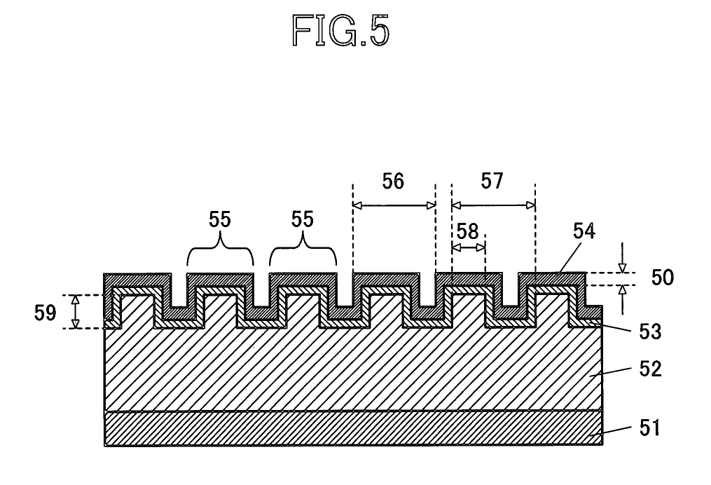

A structure of a discrete track medium of the present invention will be described referring to FIG. 5. In FIG. 5, the code 50 means the thickness of the magnetic recording layer, 51 a substrate, 52 a soft magnetic underlayer having a concavo-convex pattern structure at the surface of the air bearing surface side of the medium, 53 a base layer for controlling crystallographic orientation, 54 a recording layer, 55 a data track, 56 a pitch of the data track, 57 a repeated cycle of the concavo-convex pattern structure, 58 a width of the convex part in the cross-track direction, and 59 a height of the concave part in the direction perpendicular to the substrate surface.

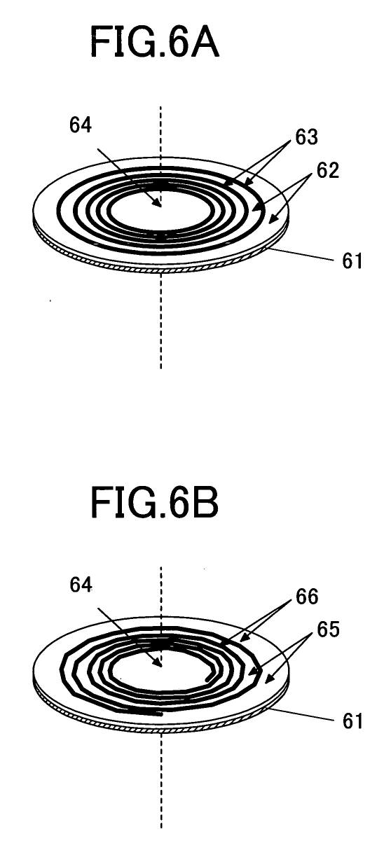

At this time, as shown in FIG. 6A, the aforementioned concavo-convex pattern structure may assume a concentric circular shaped structure around the rotation center of the magnetic recording medium. Moreover, the aforementioned pattern structure may assume a spiral shaped structure in which the rotation center side of a magnetic recording medium is the starting point. In FIGS. 6A and 6B, the code 61 means a substrate, 62 a convex part of the soft magnetic underlayer formed in a concentric circular shape, 63 a concave part of the soft magnetic underlayer formed in a concentric circular shape, 64 a rotation center of the substrate, 65 a convex part of the soft magnetic underlayer formed in a spiral shape, and 66 a concave part of the soft magnetic underlayer formed in a spiral shape.

It is preferable that, in the concavo-convex pattern structure formed at the surface of the air bearing surface side of the medium of the aforementioned soft magnetic underlayer, the pitch (repeated cycle) shown as the code 57 in FIG. 5 is so constituted as to be the same as the pitch (code 56) of the data track as seen from the air bearing surface of the medium. Moreover, it is preferable that the aforementioned concavo-convex pattern structure has the dimensions in which the width of the convex part in the cross-track direction (code 58) corresponding to the data track is from 0.3 times to 0.85 times the pitch of the data track (code 56). In order to obtain a magnetic recording layer having an excellent perpendicular magnetic anisotropy and excellent read/write properties, the sum of the film thicknesses of the base layer for controlling crystallographic orientation and the magnetic recording layer is preferably in the region from 20 nm to 70 nm. If the width of the convex part is from 0.3 times to 0.85 times the pitch of the data track, the base layer for controlling crystallographic orientation and the magnetic recording layer which have the sum of the film thicknesses from 20 nm to 70 nm can be stacked free of voids in a uniform film thickness along the concavo-convex pattern structure. If the width of the convex part is less than 0.3 times the pitch of the data track, there is a possibility that the stacking condition of the base layer for controlling crystallographic orientation and the magnetic recording layer which are stacked on the convex part becomes worse, and a magnetic recording layer will be formed which does not have excellent crystallographic orientation and perpendicular magnetic anisotropy. Moreover, if the width of the convex part is greater than 0.85 times the pitch of the data track, in the case when the base layer for controlling crystallographic orientation and the magnetic recording layer are stacked on the convex part, it is undesirable that the magnetic recording layer rises at the edge of the convex part which becomes the data track and that the surface roughness increases, which would result in a crash of the magnetic head during a read/write using the magnetic head.

Moreover, in the aforementioned structure, the concave part corresponding to the space between the data tracks preferably has the dimensions in which the height (code 59) in a direction perpendicular to the surface of the substrate is from 0.7 times to 5 times the film thickness of the magnetic recording layer (code 50). As mentioned above, in order to obtain a magnetic recording layer having an excellent perpendicular magnetic anisotropy and excellent read/write properties, the sum of the film thicknesses of the base layer for controlling crystallographic orientation and the magnetic recording layer is preferably in the region from 20 nm to 70 nm. If the height of the convex part is from 0.7 times to 5 times the height of the magnetic recording layer, the base layer for controlling crystallographic orientation and the magnetic recording layer which have the sum of the film thickness from 20 nm to 70 nm can be stacked in a uniform film thickness on the entire surface of the concave part and convex part of the concavo-convex pattern structure as shown in FIG. 5. If the height of the concave part in a direction perpendicular to the surface of the substrate is less than 0.7 times the film thickness of the magnetic recording layer, in the case when the base layer for controlling crystallographic orientation and the magnetic recording layer are stacked thereon, it is undesirable that the magnetic recording layer rises at the edge of the convex part which becomes the data track and that the surface roughness increases, which would result in a crash of the magnetic head during a read/write using the magnetic head. Moreover, if it is greater than 5 times, there is a possibility that the stacking condition of the base layer for controlling crystallographic orientation and the magnetic recording layer becomes worse and a magnetic recording layer is formed which does not have excellent crystallographic orientation and perpendicular magnetic anisotropy.

In the present invention, a non-magnetic material or a soft magnetic material is not embedded in the concave part of the pattern structure on the soft magnetic underlayer, just like a conventional discrete track medium. If the size, pitch (cycle), and shape of the aforementioned concavo-convex pattern structure are optimized as mentioned above, it is possible to form the magnetic recording layer uniformly along the concavo-convex patterned shape as shown in FIG. 5, and the roughness of the data track on the air bearing surface of the medium can be made to have almost the same value as that of a conventional continuous medium. Moreover, if the roughness of the data track and the edge are almost the same as that of the conventional medium even if the grooves remain between the data tracks like the present invention, it is possible to form a medium overcoat and a lubricant layer on the air bearing surface of the discrete track medium of the present invention, combine it with the read/write head, and float the head by rotating the medium to perform read/write operations of the magnetic information as will be mentioned later.

In the present invention, since a material is not embedded in the space between the data tracks, a CMP process for the magnetic recording layer, which is necessary for the discrete track fabricated by applying cutting-work to the magnetic recording layer, becomes unnecessary, so that no deterioration occurs in the magnetic properties of the magnetic recording layer. Moreover, since a CMP process is also not applied to the base layer controlling for crystallographic orientation in the present invention, a discrete track type perpendicular magnetic recording medium which has excellent crystallographic orientation and perpendicular magnetic anisotropy of the magnetic recording layer can be obtained. Since the base layer for controlling crystallographic orientation is formed along the concavo-convex pattern structure in the present invention, an excellent underlayer without a CMP process history and a thermal history caused by cutting-work exists at the edge of the convex structure which becomes a data track. Therefore, a magnetic recording layer which has excellent crystallographic orientation and perpendicular magnetic anisotropy can be obtained at the edge of the data track.

Moreover, according to the present invention, a concavo-convex pattern structure is formed by micro-fabrication only on the surface of the soft magnetic underlayer as mentioned above, and a CMP process is unnecessary for the surface of the magnetic recording layer and the base layer for controlling crystallographic orientation. As a result, a discrete track type perpendicular magnetic medium can be provided, in which the manufacturing cost is inexpensive and a complicated manufacturing process not required.

In a perpendicular magnetic recording medium of the present invention, it is preferable that the soft magnetic underlayer includes at least one element selected from the group of Fe, co, Ni, Ta, and Zr. The soft magnetic underlayer may include elements other than these. The soft magnetic underlayer may consist of a single layer film having a specific composition.

It is known that there are many magnetic domains in the soft magnetic underlayer, and controlling these magnetic domains is important to reduce the medium noise. For this purpose, it is possible that the soft magnetic underlayer in the medium of the present invention consists of stacking a plurality of magnetic layers in which each layer is composed of a different composition. For instance, an antiferromagnetic film and a ferromagnetic material may be included in the soft magnetic underlayer for the purpose of magnetic domain control.

It is preferable that the aforementioned magnetic recording layer includes at least one element selected from Fe, Co, Cr, Pt, Pd, Si, and O, and consists of a film having magnetic anisotropy in a direction perpendicular to the surface of the substrate. A film including an element other than these elements and having perpendicular magnetic anisotropy can be used.

For the aforementioned base layer for controlling crystallographic orientation it is possible to select a best element and film thickness according to the element group and the crystal structure constituting the magnetic recording layer.

In the case when perpendicular magnetic recording is performed by combining a discrete track medium of the present invention with a read/write head, an overcoat including carbon as a main component is stacked on the aforementioned magnetic recording layer by a sputtering technique. Moreover, a lubricant which consists of a fluorine compound can be applied on the overcoat.

In the discrete track medium of the present invention, the concavo-convex pattern structure is formed on the surface of the soft magnetic underlayer stacked on the substrate, and the base layer for controlling crystallographic orientation and the magnetic recording layer are formed thereon along the concavo-convex structure. As seen from the top of the surface of this medium, the data track region having the magnetic information becomes a convex part and the space between the data tracks becomes a concave part. In the medium of the present invention, since the concave part exists at the space between the data tracks due to the concavo-convex pattern structure being formed on the surface of the soft magnetic underlayer as mentioned above, there is the advantage that the write-field gradient becomes greater compared with a conventional continuous medium when magnetic information is recorded using the write head. If the write-field gradient is large, noise at the boundary region between the write bits formed in the data track can be reduced, from which one can expect an improvement in the read S/N. Moreover, since the recording magnetic intensity can be reduced if the write-field gradient is large, a margin is created for the design of a magnetic head for which a large magnetic field intensity is required for high density magnetic recording.

In the medium of the present invention, since a space between the data tracks becomes a concave part by forming a concavo-convex pattern structure on the surface of the soft magnetic underlayer, the distance between the magnetic recording layer and the soft magnetic underlayer on the data track where the magnetic information exists becomes substantially greater. As a result, a reduction in the noise from the soft magnetic underlayer becomes possible, resulting in the read S/N being improved.

According to the present invention, it is possible not only to form a concavo-convex pattern structure by directly micro-fabricating the surface of the soft magnetic underlayer but also to provide a non-magnetic layer at the top layer of the soft magnetic underlayer composed of a plurality of films having different compositions and to form a concavo-convex pattern structure on this layer. There are many magnetic domains in the soft magnetic underlayer of the perpendicular recording medium, and it is understood that various deterioration phenomena of recorded information are caused by fluctuation of these domains. In order to prevent this, the soft magnetic underlayer does not consist of a single layer of a soft magnetic material having a high magnetic permeability, but attempts have been made to make it multi-layer consisting of a plurality of layers having different compositions such as soft magnetic material and antiferromagnetic material, etc. If a non-magnetic layer is used as the top layer of the multi-layered soft magnetic underlayer as in the present invention, a non-magnetic layer exists between the magnetic recording layer on the data track and the soft magnetic layer having a high magnetic permeability, so that it becomes difficult to receive the influence of the magnetic domain fluctuation of the soft magnetic underlayer induced by the stray field except for the read head, such as an antenna effect, and it is possible that the stability of the recorded information can be improved.

In a discrete track medium of the present invention, physical grooves and magnetic discontinuities exist between the data tracks having the magnetic information. Because of this, it is difficult to receive a magnetic influence from the adjacent data tracks like a continuous medium, so that there is an advantage that the read S/N becomes higher.

In the case of read/write using a continuous medium, there is no groove between the data tracks where the magnetic information exists. Therefore, in order to avoid the interference from the adjacent tracks, the magnetic width of the read head becomes narrower than the width of the data track on the continuous medium. On the other hand, in the discrete track medium, since grooves exist between the data tracks, a read head which has a larger width than the width of the data track can be used. Generally, a wider read head brings higher sensitivity, so that a further increase in the S/N ratio becomes possible by using a read head having a wider width.

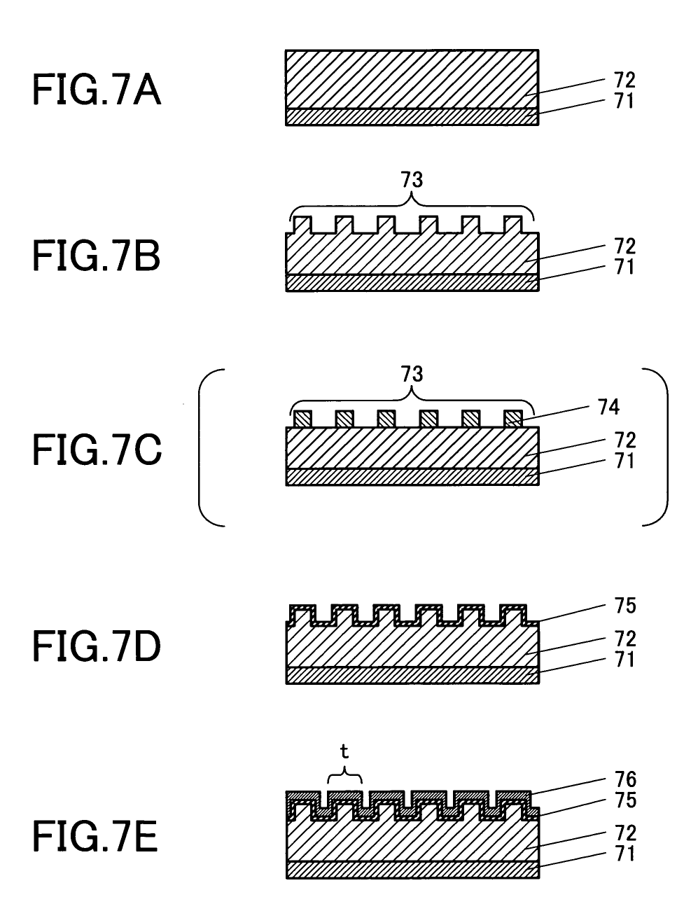

An outline of a manufacturing process of a discrete track medium of the present invention will be described as follows with reference to FIGS. 7A to 7E. First, as shown in FIG. 7A, the soft magnetic underlayer 72 is formed evenly on the substrate 71. Next, as shown in FIGS. 7B and 7C, the concavo-convex pattern structure 73, which consists of a convex part corresponding to the data track position and a concave part corresponding to the space position between the data tracks, is formed on the surface of the air bearing surface side of the medium of the soft magnetic underlayer. At this time, it is possible to form the concavo-convex pattern structure by micro-fabricating the soft magnetic underlayer as shown in FIG. 7B. As shown in FIG. 7C, it may be possible to form the convex part 74 using a magnetic or non-magnetic material having a different composition from the soft magnetic layer to constitute the concavo-convex pattern structure after forming evenly the soft magnetic underlayer. Next, as shown in FIG. 7D, on the concavo-convex pattern structure, the base layer for controlling crystallographic orientation 75 is stacked along the concavo-convex pattern structure on the concave part and the convex part without voids. Moreover, as shown in FIG. 7E, the discrete track medium is obtained by stacking the magnetic recording layer 76 on the base layer for controlling crystallographic orientation along the concavo-convex pattern structure on the concave part and the convex part without voids. In FIG. 7, the part shown as the code “t” is a data track having magnetic information. Although it is not shown in FIG. 7, after this process, an overcoat containing carbon as a main component and a lubricant layer containing a fluorine compound as a main component may be stacked in order.

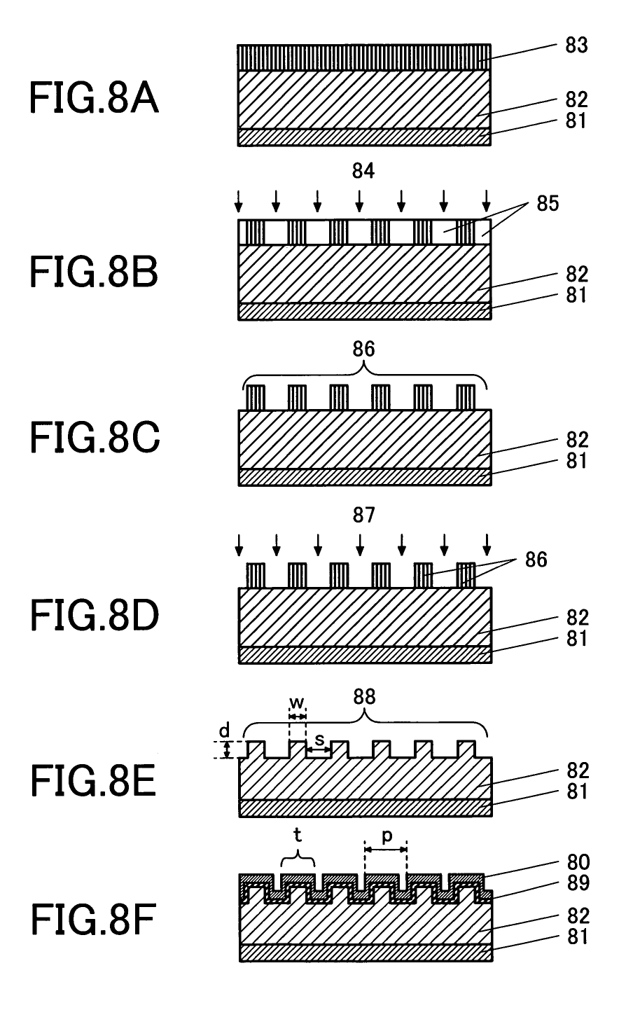

As a manufacturing method for the aforementioned concavo-convex pattern structure, in the case when the surface of the air bearing surface side of the medium of the soft magnetic underlayer formed evenly on the medium substrate is patterned by cutting-work, the means shown in FIGS. 8A to 8F can be used. First, as shown in FIG. 8A, a resist film 83 is formed on the soft magnetic underlayer 82 on top of the substrate 81; as shown in FIG. 8B, a latent image 85 of a desired fine pattern is formed on the resist film using electron beam (EB) lithography and optical lithography 84; and as shown in FIG. 8C, the resist fine pattern 86 is actualized on the magnetic layer by developing the resist layer. In lieu of the EB lithography and optical lithography, a nano-imprint technique may be used for fabricating a resist fine pattern directly, in which a mold having a concavo-convex structure is pressed onto the resist.

Then, the surface of the soft magnetic underlayer is cutting-worked using the resist fine pattern as a mask, as shown in FIG. 8D. At this time, it is possible to use a focused ion beam (FIB) technique 87 or a reactive ion etching (RIE) technique using Ga ions as a means of cutting-work. In the case when RIE is used for the cutting-work, halogen gas, for instance chlorine, or a mixed gas of CO, CO₂, and NH₃ can be used as the etching gas for the soft magnetic layer used as the under layer. Etching gases other than these can also be used. As a result of the cutting-work, the concavo-convex pattern structure 88 shown in FIG. 8E can be fabricated at the surface of the soft magnetic underlayer. As a result, the base layer for controlling crystallographic orientation 89 and the magnetic recording layer 80 are stacked to obtain a discrete track medium having the structure shown in FIG. 8F. In FIG. 8, the code “w” means the cross-sectional width of the pattern formed at the surface of the soft magnetic underlayer, and “s” means the space between tracks. Moreover, the code “d” means the depth of groove, the code “t” the data track, and the code “p” the pitch of the data track.

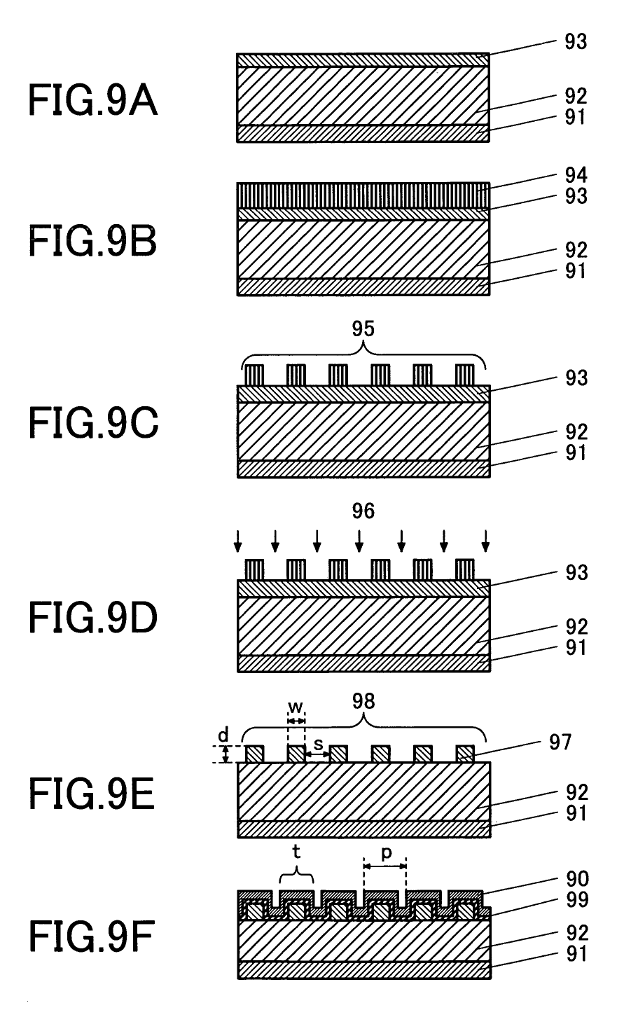

As a manufacturing process of the aforementioned concavo-convex pattern structure, it is also possible to use the means shown in FIGS. 9A to 9F. First, as shown in FIG. 9A, a cutting-work layer 93 composed of a magnetic or non-magnetic material is fabricated evenly on the soft magnetic underlayer 92 evenly formed on the substrate 91. Next, as shown in FIG. 9B, after forming the resist film 94 on the cutting-work layer 93, a resist fine pattern 95 as shown in FIG. 9C is fabricated using electron beam (EB) lithography, optical lithography, and a nano-imprint technique. Next, as shown in FIG. 9D, using the resist fine pattern as a mask, when the surface of cutting-work layer is patterned using cutting-work 96, the convex part 97 is formed on the soft magnetic underlayer 92 as shown in FIG. 9E, and it is possible to obtain the concavo-convex pattern 98. At this time, FIB and a RIE can be used for the cutting-work indicated by code 96. The composition of the cutting-work layer can be optimized by the cutting technique. In the case when RIE using a chlorine system and fluorine system halogen gas is applied, an Al₂O₃ film and a SiO₂ film, etc. are preferably used for the cutting-work layer. In the case when RIE using a mixed gas of CO, CO₂, and NH₃ is applied, it is preferable that a permalloy (FeNi) film which is easily patterned by this mixed gas and a soft magnetic film which contains Fe, Ni, and Co elements as the main components be used for the cutting-work layer. After forming the aforementioned concavo-convex pattern structure, the base layer for controlling crystallographic orientation 99 and the magnetic recording layer 90 are stacked to obtain a discrete track medium having the structure shown in FIG. 9F.

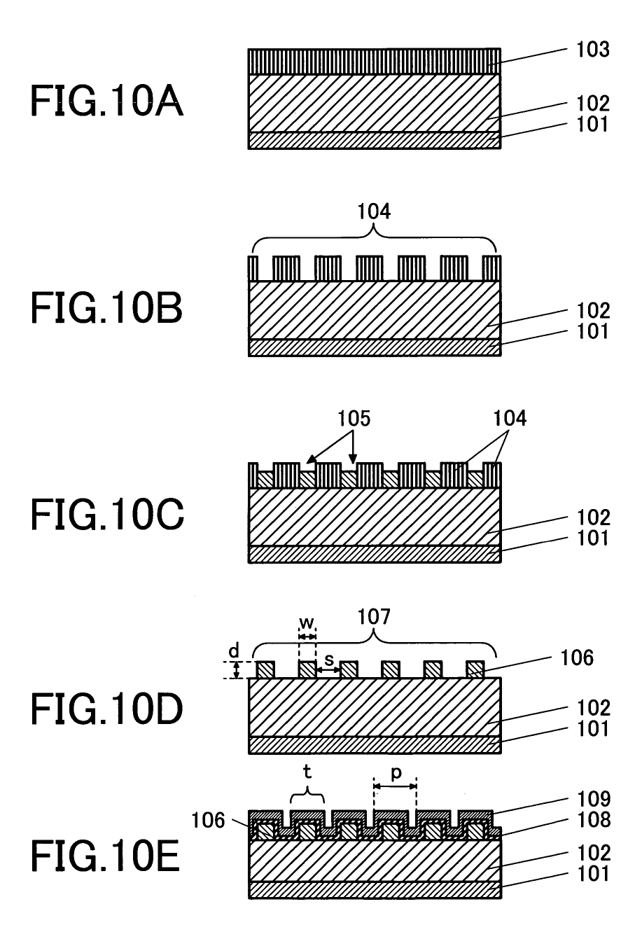

Moreover, the aforementioned concavo-convex pattern can be fabricated by forming the convex part where the magnetic or non-magnetic material is arranged at a desired position of the top layer of the soft magnetic underlayer. As shown in FIG. 10A, a resist film 103 is formed on the soft magnetic underlayer 102 on the substrate 101, and the resist fine pattern 104 is formed on the magnetic layer using electron beam (EB) lithography, optical lithography, and nano-imprinting as shown in FIG. 10B. Next, as shown in FIG. 10C, a magnetic or non-magnetic material 105 are stacked in the space between the resist fine patterns by a plating technique. Then, a convex part 106 is formed on the soft magnetic underlayer 102 by removing the resist as shown in FIG. 10D to obtain the concavo-convex pattern structure 107. At this time, it is preferable that a permalloy (FeNi), which is a soft magnetic material, be used for the convex part fabricated by a plating technique. Moreover, it is possible to fabricate the convex part by plating a non-magnetic metallic element, such as Au, Pt, and Pd. After forming the aforementioned concavo-convex pattern structure, the base layer for controlling crystallographic orientation 108 and the magnetic recording layer 109 are stacked to obtain a discrete track medium having the structure shown in FIG. 10F.

When the concavo-convex pattern structure is formed by a plating technique, it is also possible to use a means described in the following in the case when the surface roughness formed by a plating technique is large. First, the resist fine pattern is formed by using a coating type resist, which contains SiO₂ as the main component, at the surface of the soft magnetic underlayer to fill a material between the resist fine patterns by using a plating technique. Next, the surface is planarized by a CMP process, and only the resist fine pattern is etched by RIE using fluorine gas as a main component to expose the convex part and obtain the concavo-convex pattern structure.

The discrete track medium of the present invention has the structure represented in FIG. 5, and it is subdivided into the structures shown in FIG. 8F, FIG. 9F, and FIG. 10F according to the configuration of the aforementioned concavo-convex fine pattern structure. FIG. 8F is one in which the concavo-convex pattern structure is formed by processing directly the surface of the soft magnetic underlayer. In this case, paying attention to the magnetic recording layer of the data track part (code “t”), the soft magnetic underlayer exists underneath in the vicinity of this magnetic recording layer. On the other hand, the soft magnetic underlayer at the space part between data tracks (guard band) which has a concave structure is located far from the aforementioned magnetic recording layer. According to this structure, it becomes possible to make the write-field gradient greater when the magnetization information is written in the magnetic recording layer by using the perpendicular magnetic write head. If the write-field gradient is large, the recording bit size can be made smaller, resulting in a high density magnetic recording being possible. Moreover, improvement in SNR can be expected even if the magnetization information is read. The same effect can be obtained when the convex parts in FIG. 9F and FIG. 10F consist of a magnetic material.

FIGS. 9F and 10F show a structure of a discrete track medium in which the convex part of the concavo-convex pattern is composed of a material different from the soft magnetic underlayer. At this time, in the case when the convex part is composed of a non-magnetic material, the space between the magnetic recording layer and the soft magnetic underlayer becomes wider than a conventional DTM medium, so that the medium noise due to the soft magnetic underlayer can be reduced. Moreover, one can expect the effects which prevent the phenomena disturbing recorded magnetization information, such as deletion after recording and the antenna effect, as well as deterioration phenomenon.

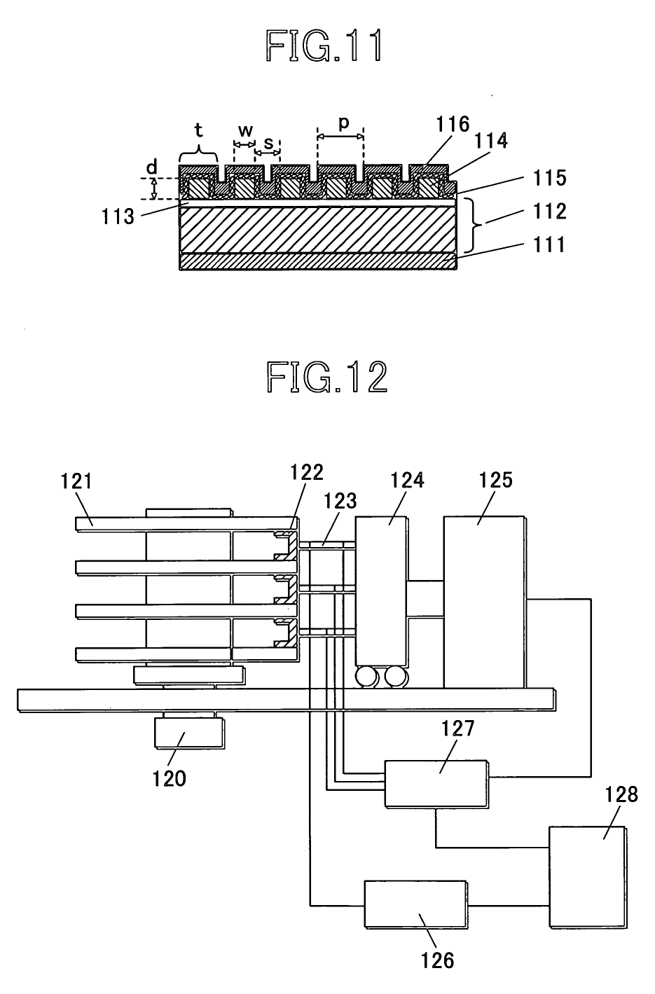

In the present invention, it is possible to fabricate the concavo-convex pattern structure shown in FIG. 11. As shown in FIG. 11, in the soft magnetic underlayer 112 consisting of a plurality of films formed on the substrate 111, the top layer of the air bearing surface side of the medium is made a planarized non-magnetic material 113 and the concave structure 114 composed of a soft magnetic material is formed at a predetermined position thereon to make a concavo-convex pattern structure. After that, the base layer for controlling crystallographic orientation 115 and the magnetic recording layer 116 are stacked in order to obtain a discrete track medium having the structure shown in FIG. 11. In the case of the medium having the structure shown in FIG. 11, since a non-magnetic material exists between the magnetic recording layer and the soft magnetic underlayer of the data track, the medium noise due to the soft magnetic underlayer can be reduced. Moreover, one can expect the effects which prevent the phenomenon disturbing the recorded magnetization information, such as deletion after recording and the antenna effect, as well as deterioration phenomenon.

The medium fabricated based on the structure of the present invention described above can be used for a discrete track medium in which the data track is partially separated from the adjacent tracks. At this time, a perpendicular magnetic recording and an optically or thermally assisted magnetic recording can be used for the recording method.

Hereinafter, the preferred embodiments of the present invention will be described. However, it is to be understood that the invention is not intended to be limited to the specific embodiments.

### First Embodiment

In the discrete track medium of the present invention, a concavo-convex pattern structure is formed on the surface of the soft magnetic underlayer and the base layer for controlling crystallographic orientation and the magnetic recording layer are stacked without voids along this structure with a uniform film thickness. To accomplish this, considering the total film thickness of the stacked base layer for controlling crystallographic orientation and the magnetic recording layer, the dimensions of the convex part and concave part of the concavo-convex pattern structure have to be optimized. Before fabricating the discrete track medium which can be used for read/write, the concavo-convex pattern structure was formed at the surface of the silicon substrate, and then the base layer for controlling crystallographic orientation and the magnetic recording layer were stacked, in order, to attempt to confirm the surface roughness.

A negative-type resist for electron beam lithography was coated by a spin-coating technique on the Si substrate; a resist fine pattern was formed by an electron beam lithography technique; using this as a mask, reactive ion etching was performed using fluorine gas; and a concavo-convex pattern structure was obtained on the surface of the silicon substrate. In the concavo-convex pattern structure, concavo-convex pattern structures having various dimensions were fabricated by changing the cross-sectional width of the convex part from 50 to 300 nm, the width of the concave part (space between the tracks) from 50 to 300 nm, and the depth of the concave part from 50 to 200 nm.

To make the track pitch 300 nm the cross-sectional width of the convex part was controlled to be 250 nm, the space between the tracks 50 nm, and the depth of groove 80 nm. The base layer for controlling crystallographic orientation and the magnetic recording layer were deposited, in order, by a sputtering technique controlling their film thicknesses to be 15 nm and 25 nm, respectively, to make a total thickness of 40 nm, resulting in the films being stacked with uniform thickness along the concavo-convex pattern structure. The surface roughness of the convex part was the same as the surface roughness of the magnetic recording layer of the continuous medium. In the same way, to make the track pitch 300 nm, the cross-sectional width of the convex part was controlled to be 270 nm, the space between the tracks 30 nm, and the depth of the groove 80 nm. The base layer for controlling crystallographic orientation (15 nm thick) and the magnetic recording layer (25 nm thick) were stacked on the concavo-convex pattern structure. As a result, it was confirmed that the magnetic recording layer rises at the edges of the convex part. According to cross-sectional SEM observations, it was discovered that the edges became 10 nm higher than the center part of the convex part. Thus, it became clear that we were able to stack the base layer for controlling crystallographic orientation and the magnetic recording layer without voids along the concavo-convex pattern structure with a uniform film thickness if the width in the track direction of the convex part was 0.85 times the data track pitch or smaller.

Next, the base layer for controlling crystallographic orientation (15 nm thick) and the magnetic recording layer (25 nm thick) were stacked on the concavo-convex pattern structure by controlling the cross-sectional width of the convex part to be 250 nm, the space between the tracks 50 nm, and the depth of the groove 130 nm, to make the track pitch 300 nm. According to cross-sectional SEM observations, there were a base layer for controlling crystallographic orientation and a magnetic recording layer on the convex part of the concavo-convex pattern structure. However, it could be observed that there was some part where the aforementioned two layers did not exist at the concave part. As a result, it was understood that the a base layer for controlling crystallographic orientation and the magnetic recording layer could not be formed along the concavo-convex pattern structure with uniform film thickness if the height of the concave part is 5 times the thickness of the magnetic recording layer or greater.

### Second Embodiment

As shown in FIG. 8A, the 300 nm thick soft magnetic underlayer 82 mainly composed of CoTaZr was formed on the glass substrate (code 81), and the positive type resist film 83 was coated thereon by a spin-coating technique. The film thickness of the resist was controlled to be 200 nm. Next, a latent image 85 of a desired fine pattern was fabricated by applying electron beam (EB) lithography 84 to the resist layer 83 as shown in FIG. 8B, and the resist layer was developed as shown in FIG. 8C to make the resist fine pattern on the surface of the soft magnetic underlayer. This pattern is a concentric circular line-and-space pattern around the rotation center of the substrate.

Next, as shown in FIG. 8D, anisotropic dry etching (RIE) was applied to the surface of the soft magnetic underlayer 82 by using a mixed gas of CO and NH₃ using the aforementioned resist fine pattern as a mask. Using it, an excellent concavo-convex pattern structure having a pattern cross-sectional width “w” of 200 nm, a space between the tracks “s” of 100 nm, and a depth of the groove “d” of 80 nm could be fabricated as shown in FIG. 8E. After this, the base layer for controlling crystallographic orientation 89 mainly composed of Ru and the magnetic recording layer 80 mainly composed of CoCrPt were stacked, in order, by a sputtering technique to obtain the discrete track medium shown in FIG. 8F. At this time, the film thicknesses of the base layer for controlling crystallographic orientation 89 and the magnetic recording layer 80 were 15 nm and 25 nm, respectively. The pitch of the concavo-convex pattern structure is defined as the sum (w+s) of the pattern cross-sectional width “w” and the space “s” between the tracks. The value of (w+s) was formed to be the same as the pitch “p” of the data track “t”.

The magnetic properties of this discrete track medium were evaluated by using a vibrating sample magnetometer. As a result, a magnetization curve having excellent magnetic properties was obtained such as an out-of plane coercivity of 200 kA/m (2500 Oe), a coercive squareness S* of 0.75, and a remanent magnetization of 100 emu/cc. Therefore, according to the aforementioned manufacturing process for a medium, a discrete track type perpendicular magnetic recording medium which had excellent magnetic properties could be fabricated.

An overcoat containing carbon as the main component was deposited on the discrete track medium fabricated in this embodiment, and a fluorine system lubricant was applied thereto to make a discrete track medium for evaluation. Combining this medium and a head which has a read element and a write element in which a thin film single pole head for perpendicular magnetic head was used as the write head and a GMR element as the read head, a magnetic disk drive was assembled. At this time, a read head was used, which had a narrower width than the width of the data track of the discrete track medium. Herein, the width of the read head means the width of magnetic sensitivity. In FIG. 12, the code 120 means a motor driving the recording medium, 121 a magnetic disk being the recording medium, 122 a magnetic head which has a read part and a write part, 123 a suspension mounting the head, 124 and 125 an actuator and a voice coil motor related to driving and positioning the magnetic head. Moreover, the code 126 means a read/write circuit, 127 a positioning circuit, and 128 an interface control circuit. As a result of the investigation of the output of the read head using this magnetic disk drive, about 1 mV of output peak-to-peak could be obtained when the recording density was 100 kfci. Moreover, it was understood that the wear resistance was of the same level as that of a conventional medium made by sputtering deposition.

### COMPARATIVE EXAMPLE

As a comparative example, a continuous medium which had the same film configuration as the magnetic recording medium fabricated by the second embodiment was formed by a sputtering technique. Therefore, the medium of this comparative example consisted of a stacked film of a soft magnetic underlayer (300 nm thick) mainly composed of CoTaZr, a base layer for controlling crystallographic orientation (15 nm thick) mainly composed of Ru, and a magnetic recording layer (25 mm thick) mainly composed of CoCrPt, in order, from the substrate to the air bearing surface of the medium. An overcoat containing carbon as the main component was deposited on the medium of this comparative example and a fluorine system lubricant was applied thereto to make a medium for evaluation. And a magnetic disk drive shown in FIG. 12 was assembled by combining it with a read/write head which is the same as the one used for the evaluation of the discrete track medium described in the second embodiment. Read S/N was measured for this medium and for the discrete track medium fabricated in the second embodiment. As a result, the S/N ratio was improved 2 dB in the discrete track medium fabricated in the second embodiment compared to the continuous medium which had the same film configuration.

Read S/N was measured for the discrete track medium fabricated in the second embodiment by using a read head which had a wider sensitivity width than the data track width of this medium. As a result, it was found that applying a wider head brought 4 dB of improvement in the S/N ratio. Conversely, a 2 dB decrease was observed in the read S/N ratio when the aforementioned medium of the comparative example was read using the same read head. The reason is due to the fact that the read S/N ratio becomes worse with a read head having a wider sensitivity width than the track width, because the comparative example consists of a continuous film and has no grooves between the data tracks. Thus, it was understood that a read head having a wider sensitivity width than the track width could be applied to the discrete track medium of the present invention. In a current magnetic recording in which the width of the read head is designed to be narrower to achieve a high recording density, being able to apply a read head wider than the data track width to the discrete track medium will result in the great advantage of allowing margin in the design.

### Third Embodiment

In lieu of the resist fine pattern which has a concentric circular line-and-space structure used in the second embodiment, a resist pattern having a spiral structure is formed on the surface of the soft magnetic underlayer. Using this resist pattern as a mask, the surface of the soft magnetic underlayer was mutually patterned by focused ion beam (FIB) using Ga ions. As a result, as shown in FIG. 8E, an excellent concavo-convex pattern structure could be fabricated on the surface of the soft magnetic underlayer, in which the pattern cross-sectional width “w” was 210 nm, the space between the tracks “s” 90 nm, and the depth of the groove “d” 100 nm. Then, the base layer for controlling crystallographic orientation 89 and the magnetic recording layer 80 having the same compositions as those of the second embodiment are stacked, in order, by a sputtering technique to obtain the discrete track medium which had a structure shown in FIG. 8F. At this time, the film thicknesses of the base layer for controlling crystallographic orientation 89 and the magnetic recording layer 80 were controlled to be 15 nm and 25 nm, respectively.

Just like the second embodiment, the magnetic properties of the substrate on which the fine pattern was formed according to the aforementioned method were evaluated using a vibrating sample magnetometer. As a result, a magnetization curve having excellent magnetic properties were obtained such as an out-of plane coercivity of 200 kA/m (2500 Oe), a coercive squareness S* of 0.75, and a remanent magnetization of 100 emu/cc. Therefore, according to the aforementioned manufacturing process for a pattern, a discrete track medium which had excellent magnetic properties could be fabricated.

An overcoat and a fluorine system lubricant were applied the same as the second embodiment to the discrete track medium fabricated in this embodiment to obtain a pattern type perpendicular recording medium for evaluation. Combining this medium with a head which has a read element and a write element consisting of a thin film single pole head for perpendicular magnetic head and a GMR element, the magnetic disk drive shown schematically in FIG. 12 was assembled, and the output was investigated. As a result, about 1 mV of output peak-to-peak could be obtained when the recording density was 100 kfci. Moreover, it was understood that the wear resistance was of the same level as that of a conventional medium made by sputtering deposition.

### Fourth Embodiment

In the second and third embodiments, a concavo-convex pattern was fabricated by directly applying micro-fabrication to the soft magnetic underlayer. In this embodiment, an example for fabricating a concavo-convex pattern structure will be described, in which a cutting-work layer is formed on the soft magnetic underlayer and a convex part is formed by micro-fabrication. The same films as the second embodiment were used for the soft magnetic underlayer, the base layer for controlling crystallographic orientation, and the magnetic recording layer stacked on the substrate.

As shown in FIG. 9A, a soft magnetic underlayer 92 mainly composed of CoCrTa was stacked on the substrate 91 by a sputtering technique, and a 100 nm thick Ni film was stacked thereon as a cutting-work layer. Next, as shown in FIG. 9B, a positive type resist film 94 was coated on the cutting-work layer by a spin-coating technique. A concentric circular resist fine pattern was fabricated (FIG. 9C) by applying a nano-imprint technique, where a mold shape with a desired fine pattern already formed on a SiN substrate is impressed against this resist layer 94. Next, as shown in FIG. 9D, micro-fabrication was performed on the surface of the cutting-work layer by anisotropic dry etching (RIE) using a mixed gas of CO and NH₃ using the aforementioned resist fine pattern as a mask. Therefore, as shown in FIG. 9E, an excellent concavo-convex pattern structure 98 could be fabricated on the surface of the soft magnetic underlayer, in which the pattern cross-sectional width “w” was controlled to be 200 nm, the space between the tracks “s” 100 nm, and the depth “d” 80 nm. At this time, the convex part 97 was obtained by cutting the Ni film.

Then, the base layer for controlling crystallographic orientation 99 and the magnetic recording layer 90 were stacked, in order, by a sputtering technique to obtain the discrete track medium which had the structure shown in FIG. 9F. At this time, the film thicknesses of the base layer for controlling crystallographic orientation and the magnetic recording layer were controlled to be 20 nm and 30 nm, respectively. The pitch (w+s) of this excellent concavo-convex pattern structure was fabricated to become the same as the pitch “p” of the data track “t”.

Just like the second embodiment the magnetic properties of the substrate on which the fine pattern was formed by the aforementioned method were evaluated by using a vibrating sample magnetometer. As a result, a magnetization curve having excellent magnetic properties was obtained such as an out-of plane coercivity of 200 kA/m (2500 Oe), a coercive squareness S* of 0.75, and a remanent magnetization of 100 emu/cc. Therefore, according to the aforementioned manufacturing process for a pattern, a discrete track type perpendicular magnetic recording medium which had excellent magnetic properties could be fabricated.

An overcoat and a fluorine system lubricant were applied the same as the second embodiment to the discrete track type perpendicular magnetic recording medium fabricated in this embodiment to obtain a pattern type perpendicular recording medium for evaluation. Combining this medium with a head which has a read element and a write element consisting of a thin film single pole head for a perpendicular magnetic head and a GMR element, the magnetic disk drive shown schematically in FIG. 12 was assembled, and the output was investigated. As a result, about 1 mV of output peak-to-peak could be obtained when the recording density was 100 kfci. Moreover, it was understood that the wear resistance was of the same level as that of a conventional medium made by sputtering deposition.

A continuous medium which had the same film configuration as the discrete track medium fabricated in this embodiment was formed by a sputtering technique and the read S/N was compared with that of a discrete track medium of this embodiment. The read head used at this time was one which was wider than the data track width. As a result, the S/N ratio was improved 2 dB in the discrete track medium fabricated in this embodiment compared with a continuous medium having the same film configuration.

### Fifth Embodiment

An embodiment in which a concavo-convex pattern structure is formed on the surface of the soft magnetic underlayer by a plating technique will be explained. As shown in FIG. 10A, a soft magnetic underlayer 102 is formed on the substrate 101 and a coating-type resist containing SiO₂ as the main component was coated thereon by using a spin coating technique to obtain the resist layer 103. Next, a resist fine pattern was formed by using a nano-imprint technique as shown in FIG. 10B. This fine pattern is a concentric circular line and space pattern. Next, as shown in FIG. 10C, the substrate was dipped into the plating solution and a soft magnetic permalloy (FeNi) was filled between the resist fine patterns by using a plating technique as shown by the code 105. Then, the surface was planarized by a CMP process and only the resist fine pattern was etched to expose the convex part by RIE using fluorine gas as a main component.

As a result, an excellent concavo-convex pattern structure 107 could be obtained on the surface of the soft magnetic underlayer shown in FIG. 10D. This pattern structure had a cross-sectional width “w” of 150 nm, a space between the tracks “s” of 150 nm, and a depth “d” of 70 nm. Then, the base layer for controlling crystallographic orientation 108 and the magnetic recording layer 109 were stacked, in order, by a sputtering technique to obtain the discrete track medium which had the structure shown in FIG. 10F. At this time, the film thickness of the base layer for controlling crystallographic orientation and the magnetic recording layer were controlled to be 20 nm and 30 nm, respectively. The pitch (w+s) of the concavo-convex pattern structure was fabricated to become the same as the pitch “p” of the data track.

An overcoat and a fluorine system lubricant were applied the same as the second embodiment to the discrete track type perpendicular magnetic recording medium fabricated in this embodiment to obtain a pattern type perpendicular recording medium for evaluation. Combining this medium with a head which has a read element and a write element consisting of a thin film single pole head for perpendicular magnetic head and a GMR element, the magnetic disk drive shown schematically in FIG. 12 was assembled, and the output was investigated. As a result, about 1 mV of output peak-to-peak could be obtained when the recording density was 100 kfci. Moreover, it was understood that the wear resistance was of the same level as that of a conventional medium made by sputtering deposition.

A continuous medium which had the same film configuration as the discrete track medium fabricated in this embodiment was formed by a sputtering technique and the read S/N was compared with that of a discrete track medium of this embodiment. The read head used at this time was one which was wider than the data track width. As a result, it was found that the S/N ratio was improved 2 dB in the discrete track medium fabricated in this embodiment compared with a continuous medium having the same film configuration.

### Sixth Embodiment

An embodiment, in which a concavo-convex pattern structure is formed on the soft magnetic underlayer through the non-magnetic layer, will be described. As shown in FIG. 11, a soft magnetic underlayer 112 consisting of a plurality of films having different compositions was formed on the substrate 111. In the soft magnetic underlayer consisting of a plurality of films, the top layer of the air bearing surface side of the medium was assumed to be an alumina layer (Al₂O₃) 113 and the film thickness was controlled to be 30 nm. The total film thickness of the soft magnetic underlayer was 200 nm, and the film thickness of the soft magnetic layer mainly composed of CoTaZr was 140 nm.

A convex structure 114 composed of permalloy FeNi was formed at a predetermined position by performing a combination of a plating technique and a CMP technique, the same as the fifth embodiment, on the alumina layer 113 shown in FIG. 11 to obtain a concavo-convex pattern structure. At this time, the concavo-convex pattern structure had a cross-sectional width “w” of 200 nm, a space between the tracks “s” of 100 nm, and a depth “d” of 80 nm. Then, the base layer for controlling crystallographic orientation 115 and the magnetic recording layer 116 which had the same components as the second embodiment were stacked, in order, to obtain the discrete track medium which had a structure shown in FIG. 11. At this time, the film thickness of the base layer for controlling crystallographic orientation and the magnetic recording layer were controlled to be 15 nm and 20 nm, respectively. In this embodiment, the pitch (w+s) of the concavo-convex pattern structure was fabricated to become the same as the pitch “p” of the data track.

An overcoat and a fluorine system lubricant were applied the same as the second embodiment to the discrete track type perpendicular magnetic recording medium fabricated in this embodiment to obtain a pattern type perpendicular recording medium for evaluation. Combining this medium with a head which has a read element and a write element consisting of a thin film single pole head for a perpendicular magnetic head and a GMR element, the magnetic disk drive shown schematically in FIG. 12 was assembled, and the output was investigated. As a result, about 1 mV of output peak-to-peak could be obtained when the recording density was 100 kfci. Moreover, it was understood that the wear resistance was of the same level as that of a conventional medium made by sputtering deposition.

A continuous medium which had the same film configuration as the discrete track medium fabricated in this embodiment was formed by a sputtering technique and the read S/N was compared with that of discrete track medium of this embodiment. The read head used at this time was one which was wider than the data track width. As a result, the S/N ratio was improved 1 dB in the discrete track medium fabricated in this embodiment compared with a continuous medium having the same film configuration.

The stray field resistance of the discrete track type perpendicular magnetic recording medium fabricated by this embodiment was measured. In a magnetic disk drive, it is thought that the main source of the stray field is a voice coil motor and that the magnetic field intensity is several tens of oersteds. Then, attenuation of the read output was measured by bringing a coil close to the rear face of the medium as a quasi-source of magnetic field and flowing a current in the coil to generate a magnetic field in a direction perpendicular to the surface of the substrate. As a result, it was understood that attenuation of the read output did not occur in the medium fabricated in this embodiment even if the external magnetic field intensity was 70 oersteds and it had an excellent stray field resistance.

In the claims:

1. A magnetic recording medium which is formed of stacking at least a soft magnetic underlayer, a base layer for controlling crystallographic orientation, and a perpendicular magnetic recording layer, in order, over a non-magnetic substrate comprising:
a concavo-convex pattern structure over the surface of said soft magnetic underlayer on the air bearing surface side of the medium in which a convex part corresponding to a data track position which records magnetic information and a concave part corresponding to a space between the proper data tracks, and in which the cycle period is the same as the track pitch of said data track,
wherein said base layer for controlling crystallographic orientation and said perpendicular magnetic recording layer are stacked free of voids on said concave part and convex part along said concavo-convex pattern structure.

2. A magnetic recording medium according to claim 1, wherein
said concavo-convex pattern structure is formed in concentric circular shape around the rotation center of a magnetic recording medium.

3. A magnetic recording medium according to claim 1, wherein
said concavo-convex pattern structure is a spiral shaped structure in which the side of rotation center of a magnetic recording medium is made to be the starting point.

4. A magnetic recording medium according to claim 1, wherein
the width of said convex part in the track-width direction is from 0.3 times to 0.85 times said data track pitch.

5. A magnetic recording medium according to claim 1, wherein
the height in the direction perpendicular to the substrate surface of said concave part is from 0.7 times to 5 times the thickness of said perpendicular magnetic recording layer.

6. A magnetic recording medium according to claim 1, wherein
said soft magnetic underlayer includes at least one element selected from the group of Fe, Co, Ni, Ta, and Zr; said perpendicular magnetic recording layer includes at least one element selected from the group of Fe, Co, Cr, Pt, Pd, Si, and O, and has a magnetic anisotropy in the direction perpendicular to the substrate surface; an overcoat containing carbon as a main component is stacked over said perpendicular recording layer; and a lubricant layer composed of a carbohydrate including fluorine is formed over said overcoat.

7. A method for manufacturing a magnetic recording medium comprising:
a process for forming a soft magnetic underlayer over a non-magnetic substrate,
a process for forming a concavo-convex pattern structure consisting of a convex part corresponding to a data track position which records magnetic information and a concave part corresponding to a space between the proper data tracks at the surface of said soft magnetic underlayer,
a process for forming a base layer for controlling crystallographic orientation by stacking free of voids on the convex part and the concave part along the concavo-convex pattern structure over said concavo-convex pattern structure,
a process for forming a perpendicular magnetic recording layer by stacking free of void on the convex part and the concave part along the concavo-convex pattern structure over said base layer for controlling crystallographic orientation.

8. A method for manufacturing a magnetic recording medium according to claim 7, wherein
a process for forming said concavo-convex pattern structure is a process for forming the surface of said soft magnetic underlayer by cutting work.

9. A method for manufacturing a magnetic recording medium according to claim 8, wherein
said cutting work is one using a focused ion beam or reactive ion etching.

10. A method for manufacturing a magnetic recording medium according to claim 7, wherein
a process for forming said concavo-convex pattern structure is a process for forming a convex part composed of a magnetic or a non-magnetic material at a predetermined position over said soft magnetic underlayer.

11. A method for manufacturing a magnetic recording medium according to claim 10, wherein
a process for forming said convex part is a process for forming a cutting work layer composed of a magnetic or a non-magnetic layer flat over said soft magnetic underlayer and for forming the surface of said cutting work layer by cutting work.

12. A method for manufacturing a magnetic recording medium according to claim 11, wherein
said cutting work is one using a focused ion beam or reactive ion etching.

13. A method for manufacturing a magnetic recording medium according to claim 10, wherein
a process for forming said convex part is a process for forming a convex part composed of a magnetic or a non-magnetic material by partially stacking at the surface of said soft magnetic underlayer.

14. A method for manufacturing a magnetic recording medium according to claim 13, wherein
a process for forming by partially stacking said convex part is a process for forming a convex part on a predetermined position at the surface of said soft magnetic underlayer by using a plating technique.

15. A hard disk drive comprising:
a magnetic recording medium which is formed of stacking at least a soft magnetic underlayer, a base layer for controlling crystallographic orientation, and a perpendicular magnetic recording layer, in order, over a non-magnetic substrate comprising: a concavo-convex pattern structure over the surface of said soft magnetic underlayer on the air bearing surface side of the medium in which a convex part corresponding to a data track position which records magnetic information and a concave part corresponding to a space between the proper data tracks, and in which the cycle period is the same as the track pitch of said data track, wherein said base layer for controlling crystallographic orientation and said perpendicular magnetic recording layer are stacked free of voids on said concave part and convex part along said concavo-convex pattern structure, a media driving part which drives said magnetic recording medium, a magnetic head in which a write head and a read head are mounted, a magnetic head driving part which drives said magnetic head to a predetermined position on said magnetic recording medium; a signal processing part which processes a write signal to said write head and a read signal from said read head.

16. A hard disk drive according to claim 15, wherein
said concavo-convex pattern structure is formed in concentric circular shape around the rotation center of a magnetic recording medium.

17. A hard disk drive according to claim 15, wherein
said concavo-convex pattern structure is a spiral shaped structure in which the side of rotation center of a magnetic recording medium is made to be the starting point.

18. A hard disk drive according to claim 15, wherein
the width of said convex part in the track-width direction is from 0.3 times to 0.85 times said data track pitch.

19. A hard disk drive according to claim 15, wherein
the height in the direction perpendicular to the substrate surface of said concave part is from 0.7 times to 5 times the thickness of said perpendicular magnetic recording layer.

20. A hard disk drive according to claim 15, wherein
said soft magnetic underlayer includes at least one element selected from the group of Fe, Co, Ni, Ta, and Zr; said perpendicular magnetic recording layer includes at least one element selected from the group of Fe, Co, Cr, Pt, Pd, Si, and O, and has a magnetic anisotropy in the direction perpendicular to the substrate surface; an overcoat containing carbon as a main component is stacked over said perpendicular recording layer; and a lubricant layer composed of a carbohydrate including fluorine is formed over said overcoat.
